(19) United States
(12) Patent Application Publication
(10) Pub. No.: US 2021/0248655 A1
(43) Pub. Date: Aug. 12, 2021

(54) SYSTEMS AND METHODS FOR FACILITATING GIFT GIVING

(71) Applicant: SOS Solutions, lnc., Tonasket, WA (US)

(72) Inventors: Samuel R. Peacemaker, Gilbert, AZ (US); Benjamin Peacemaker, Chandler, AZ (US)

(73) Assignee: SOS Solutions, lnc., Tonasket, WA (US)

(21) Appl. No.: 17/163,792

(22) Filed: Feb. 1, 2021

Related U.S. Application Data
(60) Provisional application No. 62/971,096, filed on Feb. 6, 2020.

(51) Int. Cl. G06Q 30/06; G06Q 30/02

(52) U.S. Cl. CPC G06Q 30/0621; G06Q 30/0279; G06Q 30/0641; G06Q 30/0625

(57) ABSTRACT

A method is provided comprising receiving, at a gift facilitation system, donee preferences, curating, by the gift facilitation system, at least one of a product or a service based on the donee preferences, displaying, by the gift facilitation system, the curated at least one of a product or a service, and transmitting, by the gift facilitation system, an order to a merchant system. A method if further provided herein comprising, receiving, at a gift facilitation system, donee preferences, curating, by the gift facilitation system, at least one of a product or a service based on the donee preferences, displaying, by the gift facilitation system, the curated at least one of a product or a service, and receiving, by the gift facilitation system, gift contingency parameters.

### CROSS REFERENCE TO RELATED APPLICATIONS

This application is a nonprovisional of, and claims priority to, U.S. Provisional Application No. 62/971,096, entitled “SYSTEMS AND METHODS FOR FACILITATING GIFT GIVING” and filed on Feb. 6, 2020, which is hereby incorporated by reference for all purposes.

### FIELD

The present disclosure generally relates to systems and methods for facilitating gift giving.

### BACKGROUND

Gift giving, especially to celebrate holidays or life events, is a tradition amongst much of the world's population. However, gift giving can be problematic from an economic perspective. “A potentially important microeconomic aspect of gift-giving is that gifts maybe mismatched with the recipients' preferences. In the standard microeconomic framework of consumer choice, the best a gift-giver can do with, say, $10 is to duplicate the choice that the recipient would have made. While it is possible for a giver to choose a gift which the recipient ultimately values above its price-for example, if the recipient is not perfectly informed-it is more likely that the gift will leave the recipient worse off than if she had made her own consumption choice with an equal amount of cash. In short, gift-giving is a potential source of deadweight loss.” Waldfogel, Joel, 1993. “The Deadweight Loss of Christmas,” American Economic Review, American Economic Association, vol. 83(5), pages 1328-1336, December. In that regard, the area of gift giving has this, and other, areas upon which to improve.

### SUMMARY

In various embodiments, a method is provided comprising receiving, at a gift facilitation system, donee preferences, curating, by the gift facilitation system, at least one of a product or a service based on the donee preferences, displaying, by the gift facilitation system, the curated at least one of a product or a service, and transmitting, by the gift facilitation system, an order to a merchant system.

In various embodiments, a method is provided comprising, receiving, at a gift facilitation system, donee preferences, curating, by the gift facilitation system, at least one of a product or a service based on the donee preferences, displaying, by the gift facilitation system, the curated at least one of a product or a service, and receiving, by the gift facilitation system, gift contingency parameters.

In various embodiments, a method is provided comprising receiving, at a gift facilitation system, a crowd campaign, and receiving, by the gift facilitation system, contributions to the crowd campaign.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures.

FIG. 1A shows a gift facilitation distributed system, in accordance with various embodiments;

FIG. 1B shows a gift facilitation distributed system, in accordance with various embodiments;

FIG. 2 shows a gift facilitation method, in accordance with various embodiments;

FIG. 3 shows a gift facilitation method having a gift contingency feature, in accordance with various embodiments;

FIG. 4 shows a gift facilitation distributed system having a gift contingency feature, in accordance with various embodiments;

FIG. 5 shows a gift facilitation distributed system having a gift contingency feature, in accordance with various embodiments;

FIG. 6 shows a gift facilitation distributed system having a physical contingency feature, in accordance with various embodiments;

FIG. 7 shows a gift facilitation method, in accordance with various embodiments;

FIG. 8 shows a gift facilitation distributed system, in accordance with various embodiments; and

FIG. 9 shows a gift facilitation method having a gift contingency feature, in accordance with various embodiments.

### DETAILED DESCRIPTION

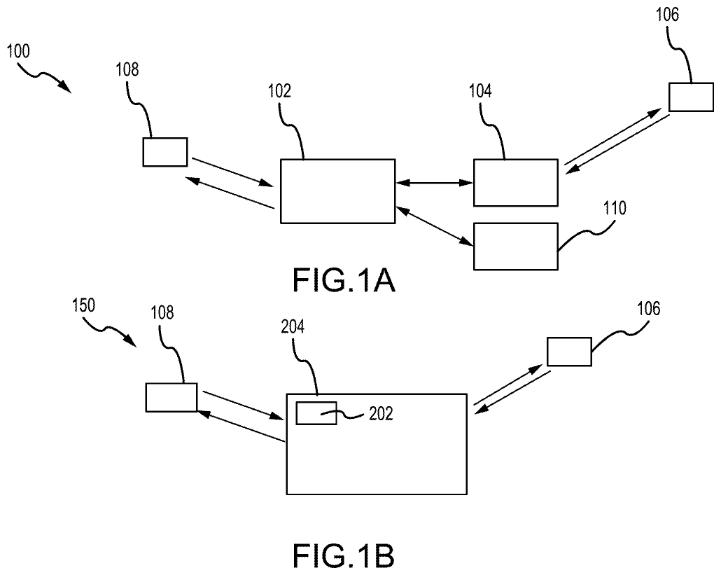

With reference to FIG. 1A, in accordance with various embodiments, a gift facilitation distributed system 100 is depicted. Gift facilitation distributed system 100 may comprise a gift facilitation system 102, an online merchant 104 and/or online merchant 110, a gift acceptor (“donee”) device 106 and a gift giver (“donor”) device 108. In that regard, the donee device 106 may be associated with a person who receives a gift and the donor device may be associated with a person who gives the gift. In that regard, donor device 108 may receive data directly from a donor and donee device 106 may receive data directly from a done. Gift facilitation distributed system 100, and any of the components comprised therein, may be computer-based, cloud-based, and may comprise a processor, a tangible non-transitory computer-readable memory, and/or a network interface. Instructions stored on the tangible non-transitory memory may allow gift facilitation distributed system 100 or any of its components to perform various functions, as described herein. As described below, as used herein, arrows indicate the exchange of data between various components. Data exchange may be via an Application Programming Interface (API), XML, other structured data format, an unstructured data format, text file, delimited file, portable document format, or any other data exchange format, as more fully described herein.

In various embodiments, gift facilitation system 102, online merchant 104 and 110, donor device 108 and donee device 106 may comprise hardware and/or software components configured to exchange data as described herein.

With reference to FIG. 1B, in accordance with various embodiments, a gift facilitation distributed system 150 is depicted. Gift facilitation distributed system 150 may comprise a gift facilitation system 202 housed within online merchant 204, a gift acceptor (“donee”) device 106 and a gift giver (“donor”) device 108. In that regard, gift facilitation distributed system 150 is similar to gift facilitation distributed system 100, except that gift facilitation system 202 is implemented as a “plug in” or other supplemental configuration of online merchant 204.

In many instances, a donor giving a gift to a donee may know the donee and may suspect or otherwise guess the donee's gift preferences. However, as described above, the perceptions of the donee by the donor may be flawed or inaccurate. This problem is exacerbated where the donor may not know the donee well, for example, if the donee and donor are mere acquaintances or perhaps have not met at all. While social media history and other traditional advertising data (for example, those collected by web browser based cookies) may provide an indication as to the donee's gift preferences, such data may be flawed, as such data may represent accidental clicks or views based on an aversion to certain subject matter or views based on fleeting curiosity as opposed to genuine interest.

In various embodiments, a donee is able to directly input data into a gift facilitation module, leaving little to no doubt as to the donee's gift preferences. Stated another way, the donee is able to directly input gift preferences so that the gift facilitation module may curate a group of products and/or services to present to a potential donor with a high degree of confidence that the donee will enjoy and/or appreciate the gift. Moreover, the donee may provide the gift facilitation system private gift parameters that gift facilitation system shields from donor. In this manner, the product or service given as a gift may have certain aspects selected based upon private gift parameters input by the donee without disclosing such private gift parameters to the donor. This may reduce the need for the donor to ask potentially sensitive questions to the donee.

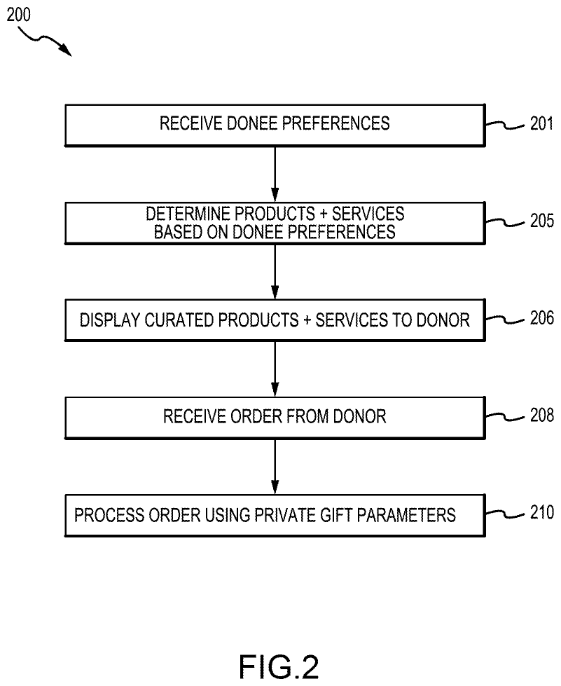

With reference to FIGS. 1A and 2, a gift facilitation method 200 is illustrated. In step 201, the gift facilitation system 102 receives donee preferences. Donee preferences may comprise activities in which the donee is interested (e.g., hunting, fishing, hiking, camping, wood working, hobbies, car repair, home repair/remodeling, sports such as basketball, football, baseball, hockey and lacrosse, fitness, cross training, and photography), donee brand preferences for various products, products donee already owns and potential accessories or complementary goods thereof, foods and restaurants donee prefers, books and authors donee prefers, movies and other media donee prefers, and the like. Donee preferences may further comprise food and diet restriction preferences (whether for personal preference, health related reasons, medical reasons, and/or religious reasons), travel and vacation preferences, entertainment preferences such as music preferences, clothing & accessories style preferences such as cosmetics preferences, perfume preferences, jewelry preferences, home decor preferences such as artwork preferences, home furnishings preferences, and style preferences, and/or pet preferences such as dogs, cats, etc. Donee device 106 may receive this data via text or via a graphical interface wherein the donee is presented with potential products and services and selects or gestures to indicate a preference for or against a product or service. For example, the donee device 106 may ask a donee to swipe in one direction for an affirmative response and another direction for a negative response.

Moreover, the donee device may input private gift parameters that are not shared with donors. Private gift parameters may comprise information that the donee may not want generally shared but that may nonetheless influence a potential order for a product or service. For example, private gift parameters may include donee's clothing sizes (e.g., shirt size, pants size, dress size, undergarment size, hand size, shoe size), donee's height and weight, donee's desired shipping address, donee's preferred clothing colors, donee's preferred device platform (e.g., iOS user vs. Andriod OS user), donee's desired streaming media platforms (e.g., APPLE vs. DISNEY+vs. NETFLIX), and any other donee parameter that may be withheld from the donor.

By continuing to accept the gift preferences from the donee, gift facilitation system 102 may continue to step 205 by determining products and services based on the donee preferences. Step 205 may thus comprise curating a group of products and services aligned with the donee preferences. For example, products and services that accompany, assist, facilitate, or otherwise fit within a donee's preferences may be selected. The products and services may be obtained from or passed to online merchants 104 and 110. In that regard, online merchants 104 and 110 may be queried by gift facilitation system 102 to determine if online merchants 104 and 110 sell a particular product or service. In various embodiments, gift facilitation system 102 passes specific items (e.g., via SKU or item number) to online merchants 104 and 110.

In step 206, the group of curated products and services is displayed to donor. The donor device 108 may interact with online merchants 104 and 110 and/or with gift facilitation system 102 directly. Donor device 108 may see all or part of the curated products and services from one or more of online merchants 104 and 110. In effect, the donor device 108 may view a custom “department store” that is closely curated to the individual likes and tastes of the donee, as revealed by the preferences directly input by the donee. In that regard, the curated products and services highly align with the interests of the donee, and the donee would highly likely enjoy, make use of, benefit from, and otherwise appreciate a gift that comes from the curated products and services.

Further in step 206, the donor device 108 may request that a potential gift (i.e., a potential product or service) be sent to the donee device 106 for the donee to review and provide feedback. In this manner, the donee device 106 may display the potential gift (which may be accompanied by a push notification to donee device 106) and a selection in a user interface on donee device 106 may be made to express interest in the potential gift. Thus, donee device 106 may indicate that the potential gift is desired, and such information may be passed to the donor device 108. In various embodiments, the identity of donor device 108 is not displayed on donee device 106. In various embodiments, the price of the potential gift is also not displayed on donee device 106. Moreover, donee device 106 may display an instant message interface or other user interface whereby messages (e.g., free text) may be typed into donee device 106 and passed to donor device 108 via at least one of online merchants 104 or gift facilitation system 102. In that regard, the instant message interface or other user interface may convey desired characteristics of the potential gift to donor device 108, such as desired color, shape, size, etc. In various embodiments, the instant message interface or other user interface may not be sent to donor device 108 but may instead inform at least one of online merchants 104 or gift facilitation system 102 of private gift parameters (as further discussed herein), such as, for example, a desired color, size, shape, or other characteristic of the potential gift. In various embodiments, pre-populated fields, drop down menus, radio buttons, or other structured formats are employed to solicit feedback from the donee device 106 regarding desired color, size, shape, or other characteristic of the potential gift. In this manner, the donee device 106 has the ability to set private gift parameters in response to being presented with a potential gift, in addition to the ability to select private gift parameters prospectively, as further described herein.

After a purchasing decision has been made, donor device 108 sends, and gift facilitation system 102 and/or online merchants 104 and 110 receives, an order for a particular product or service in step 208. The order may lack certain features traditionally associated with an order, such as shipping address, size, color, platform, or other such parameter.

In that regard, in step 210, the order is processed by at least one of gift facilitation system 102 and/or online merchants 104 and 110 in accordance with the donee' s private gift parameters. For example, donor device 108 may transmit an order for a dress. At least one of gift facilitation system 102 and/or online merchants 104 and 110 may accept the order and select, for example, a dress size and color preference in accordance with the donee's private gift parameters. The order may lack a shipping address. To that end, at least one of gift facilitation system 102 and/or online merchants 104 and 110 may select a shipping address in accordance with donee' s private gift parameters.

In this manner, the donee's private gift parameters may be implemented but may remain protected from the donor device. In that regard, even the location of the donee' s shipping address may be protected from the donor device. This arrangement ensures privacy, especially where a donor may not know a donee well. Moreover, this arrangement protects sensitive information, such as personal measurements, from donors. In that regard, the functioning of the systems are improved because of improved privacy and safety.

In fulfilling the order, the online merchants 104 and 110 may delay, expedite, or space shipments of gifts in accordance with donee's private gift parameters or parameters input by donor device 108. For example, a birthday present may be shipped on multiple days to build excitement in the donee. Also for example, a donee's private gift parameters may specify that all gifts associated an event (such as a birthday) arrive on the same day for convenience, though the order may be placed days or weeks earlier. In various embodiments, in response to fulfilling the order, a push notification may be sent to donee device 106 and displayed in a user interface on donee device 106. The push notification may comprise an in-app notification, a text message, a social media post, or similar notification. The push notification may comprise data indicating a total number of gifts purchased for the donee in the aggregate across multiple donors in a given time period. Moreover, the push notification may aggregate gift count by donee event.

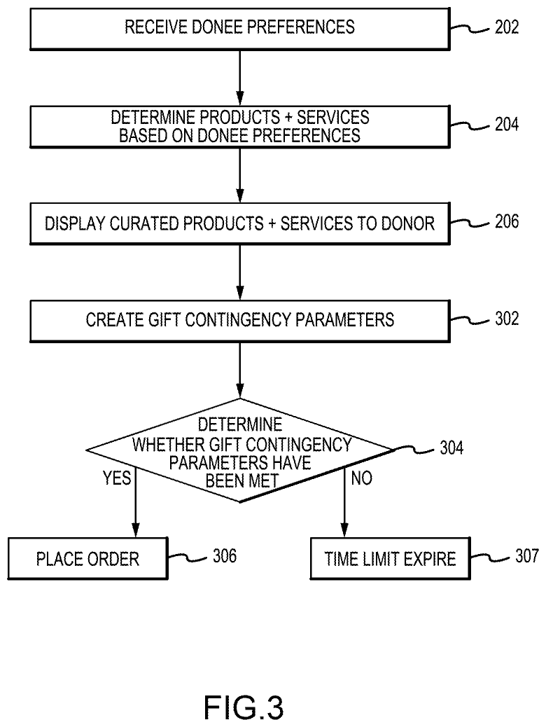

With reference to FIGS. 1A and 3, a gift facilitation distributed system having a gift contingency feature and method of using the same are shown. As above, steps 201, 205, and 206 are the same as in FIG. 2. In step 302, donor device 108 may set gift contingency parameters. Gift contingency parameters may comprise parameters that must be met prior to an order being generated for a gift to the donee. Gift contingency parameters may comprise any event, occurrence, or other parameter that may occur to trigger the placement of an order. Gift contingency parameters may further include a time limit in which another gift contingency parameter must become true prior to the order being placed. In various embodiments, donor device 108 may provide payment to the gift facilitation system 102 and/or online merchant 104 at or near the time of setting the gift contingency parameters. In this manner, the gift facilitation system 102 and/or online merchant 104 may realize payment even though a period of time may elapse prior to the gift contingency parameters occurring.

In various embodiments, a gift contingency parameter may comprise the achievement of a health goal of the donee, an achievement in a video game or sport of the donee, educational attainment of the donee, marriage of the donee, birth of a child of the donee, a change in residence of the donee, a career change of the donee, a business related goal of the donee, a weather event, a political election, or any other event or occurrence specified by the donor. In various embodiments, a gift contingency parameter may comprise an achievement status in a gaming system or a total time of video game streaming performed in a given amount of time. A time parameter may also be a gift contingency parameter such that another a gift contingency parameter must occur within the specified time period.

In various embodiments, for example, a donor device 108 may set a gift contingency parameter of the donee losing a predetermined amount of weight, achieving a predetermined health marker such as predetermined cholesterol level or an average blood glucose level in a predetermined time period. In various embodiments, donor device 108 may set a gift contingency parameter of the donee achieving an athletic goal such as a predetermined running time, a predetermined time spent on an aerobic machine, a predetermined weight lifted in a given weight lifting exercise, or a predetermined number of points scored in a game in a predetermined time period. In various embodiments, donor device 108 may set a gift contingency parameter of the donee achieving a predetermined academic degree such as a bachelor's degree or master's degree, achieving above a predetermined score on an academic test, obtaining entry into a given set of colleges, or achieving a predetermined class rank in a predetermined time period. In various embodiments, the donor device 108 may make a gift contingency parameter that is self-directed (such as a New Year's resolution) such that a personal achievement of the gift contingency parameter triggers, as discussed herein, a gift to oneself

In various embodiments, donor device 108 may provide input to notify at least one of the gift facilitation system 102 and/or online merchant 104 of the fulfillment of the gift parameter. However, in various embodiments, at least one of the gift facilitation system 102 and/or online merchant 104 may be notified of the fulfillment of the gift parameter by a third party system or device.

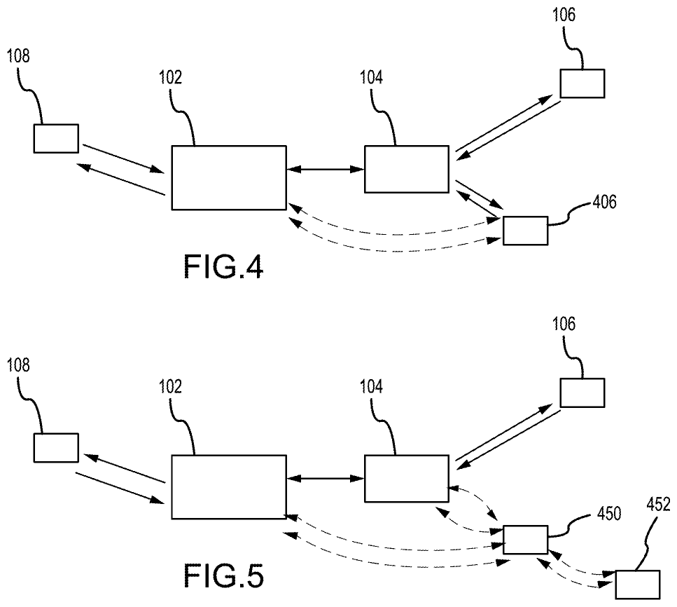

With reference to FIG. 4, gift facilitation distributed system 100 is shown having feedback device 406. Feedback device 406 may provide notification to at least one of the gift facilitation system 102 and/or online merchant 104 of the fulfillment of the gift parameter. For example, in various embodiments, feedback device 406 may comprise a health monitoring wearable device such as a smart watch or a fitness monitoring device (e.g. an Apple Watch or FITBIT) or an Internet of Things (IoT) enabled smart scale, exercise equipment (e.g. PELOTON stationary bike or treadmill). In such embodiments, the smart watch or a fitness monitoring device may notify at least one of the gift facilitation system 102 and/or online merchant 104 of a health or athletic goal such as number of miles run in a predetermined time period or a recent weight of a donee or average of recent weights of a donee. Feedback device 406 may also comprise an athletic data system, such as a system that keeps track of participants in a race and their respective times. Feedback device 406 may also comprise an educational data system that reports educational attainment and/or test scores to at least one of the gift facilitation system 102 and/or online merchant 104.

In various embodiments, feedback device 406 is a gaming system. The gaming system may verify that a certain gaming metric was achieved, such as achieving a given score, accomplishing a given feat, or other accomplishment within the gaming system. Feedback device 406 may further comprise an online streaming service, such as one used to stream video game playing feeds. The gift contingency parameters may include a predetermined number of hours of streaming within a given time period.

With reference to step 304, it is determined whether the gift contingency parameters are met. If yes, step 306 comprises placing the order in a manner similar to step 210, above. If no, the gift contingency parameters may become null. In embodiments having a feedback device 406, verification of the gift contingency parameter originates directly from the donee and not from the donor. This makes the placement of the order in step 306 to occur entirely in response to notification of data that the contingency parameters are met, thus removing the opportunity for the donor to stop or modify the order. In step 306, for example, the product or service that is the subject of the order may include an in-game purchase in a gaming system. For example, at least one of the gift facilitation system 102 and/or online merchant 104 may communicate with feedback device 406, in embodiments where feedback device 406 is a gaming system, to facilitate the gifting of an in-game purchase, upgrade or addition of in-game currency in the gaming system for the benefits of the donee. For example, the gift may be the purchase of various in-game “skins,” weapons, tools, virtual currency, or add-on packs. In step 307, the time limit expires without the contingency parameters being met, and thus no further action may be taken.

The method of FIG. 3 may also be implemented by the system shown in FIG. 5. In FIG. 5, feedback device 452 may interact with a distributed ledger 450. Feedback device 452 may comprise the same devices or systems as feedback device 406. In various embodiments, donor device 106 acts as feedback device 452.

Distributed ledger systems provide a decentralized database that is consensually shared and synchronized without a central administrator or intermediate party. The decentralized database may exist across several locations and/or among multiple participants. The distributed ledger system may process, validate, and/or authenticate writes and data exchanges to the decentralized database. For example, in a blockchain implementation, the system may provide features and functionality including consensus-based validation, immutability, and cryptographically chained blocks of data.

The distributed ledger may use features and functionality of blockchain technology including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

The blockchain may be based on any blockchain technology such as, for example, ETHEREUM®, OPENCHAIN®, Chain Open Standard technology, HYPERLEDGER® Fabric, CORDA®, Connect™, Sawtooth™, etc. The blockchain may comprise a system of blocks containing data that are interconnected by reference to the previous block. Each block may link to the previous block and may include a timestamp. Data can be added to the blockchain by establishing consensus between the blockchain nodes based on proof of work, proof of stake, practical byzantine fault tolerance, delegated proof of stake, or other suitable consensus algorithms. When implemented in support of gift facilitation system 102, the blockchain may serve as an immutable log for the deployment of cloud-based systems and related contracts and processes.

With renewed reference to FIG. 5, feedback device 452 may interact with distributed ledger 450 to record an event or other data in the distributed ledger 450. Once recorded, at least one of the gift facilitation system 102 and/or online merchant 104 may interact with distributed ledger 450 and detect the record created by feedback device 452. Then, given the verification of the record in the distributed ledger 450, the at least one of the gift facilitation system 102 and/or online merchant 104 may proceed to place the order. By performing verification via the distributed ledger 450, the occurrence of gift contingency parameters is authenticated and provides a degree of platform independence. In various embodiments, multiple donee devices 106 may be designated on the distributed ledger 450, thus allowing multiple donees to participate in a single set of gift contingency parameters.

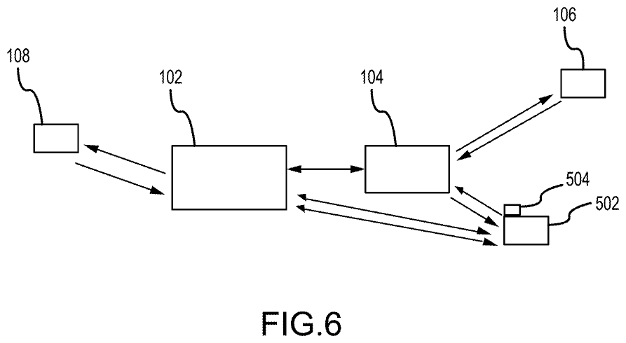

With reference to FIG. 6, gift facilitation distributed system 600 is shown. Gift facilitation distributed system 600 is similar to gift facilitation distributed system 400. However, gift facilitation distributed system 600 includes storage vessel 502 operatively coupled to lock 504. Lock 504 may comprise a physical deterrent lock such as a padlock, combination lock, shackle, clevis and/or other mechanical device to prevent or deter opening of storage vessel 502. Lock 504 may comprise an Internet of Things (IoT) device that is operatively coupled to the physical deterrent lock that prevents physical access to the contents of storage vessel 502. The IoT device may comprise an RF enable transmitter to communicate using wireless communication technologies, as described below, placing lock 504 in communication with at least one of the gift facilitation system 102 and/or online merchant 104. Lock 504 may thus be in communication with at least one of the gift facilitation system 102 and/or online merchant 104. In that regard, when a gift contingency parameter is achieved, at least one of the gift facilitation system 102 and/or online merchant 104 may send a notification to lock 504 to actuate the physical deterrent lock or reveal a code that may be used to open the physical deterrent lock and allow access to the contents of storage vessel 502. This configuration allows a gift to be delivered to a donee, but the use of the gift is prevented until the gift contingency parameter is achieved and lock 504 is able to be opened. Lock 504 may be integrated with storage vessel 502 or may be separable from storage vessel 502. In various embodiments, lock 504 is a combination lock and, at the achievement of the gift contingency parameter, at least one of the gift facilitation system 102 and/or online merchant 104 may display on donee device 106 a combination to unlock lock 504.

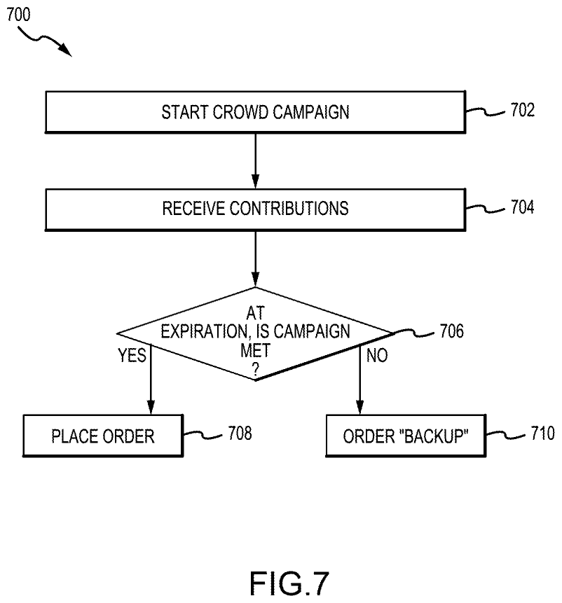

With reference to FIG. 7, a crowd gifting method is illustrated. Often, for weddings or other large events, multiple donors may desire to contribute to a high value mutual gift. To alleviate the logistical hurdles in such a process, method 700 allows mutual gift to become funded by multiple donors. In step 702, a crowd campaign is started. In that regard, a donor device may establish a proposed gift and a level of total contributions needed to purchase the gift. At the same time, a donor device may select a backup gift to order should the campaign fall short of the goal. Also in step 702, a donor device sets a time period in which potential contributions will be accepted.

In step 704, the crowd campaign is distributed to multiple users, for example using mutual friends of the donee via a social network, email or the like. Donor devices may contribute funds and, at the same time, select backup gifts. The back up gifts may be from a curated list as described above.

In step 706, the time period for contributions expires and it is determined whether the campaign has raised sufficient funds to purchase the mutual gift. If sufficient funds have been raised, in step 708, at least one of the gift facilitation system 102 and/or online merchant 104 places the order for the gift. As described above, the order placement may proceed as in step 210 of FIG. 2. If sufficient funds have not been raised, in step 710, at least one of the gift facilitation system 102 and/or online merchant 104 places the order for the one or more back up gift. As described above, the order placement may proceed as in step 210 of FIG. 2.

In this manner, donors who may not even know one another may be connected with one another in the cause of a mutual donee to provide a gift of significance to the donee. Such a system reduces processing times and enables a such a mutual gift to be given where it could not have been before absent extensive correspondence between multiple parties who may have little to no familiarity with one another.

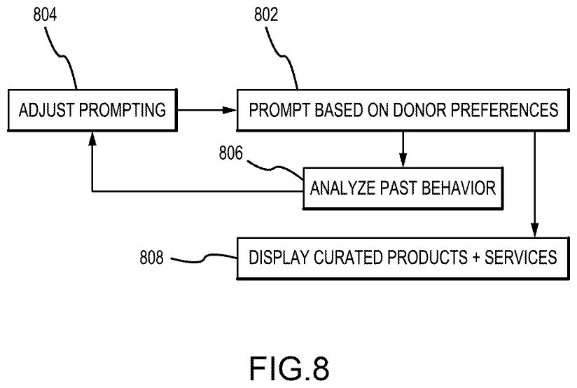

With reference to FIG. 8, a proactive gift facilitation method 800 is shown. In step 802, a gift facilitation system prompts a donor device based on various donee preferences. The prompt may be driven by an event in the life of the donee (e.g., a birthday, Father's/Mother's Day, Christmas, a wedding or birth of a child, etc.). Curated products and services are displayed in step 808 in a manner identical to or similar to that described above. Certain curated products and services may be promoted (moved ahead in a list or displayed in a side bar, etc) by receipt of advertising funds from the sellers of the curated products and services. Because of the finely tailored curation of the curated products and services, such advertising efforts would likely result in a high conversion rate, meaning that advertising resources sent in this scenario would be highly effective.

The gift facilitation system may retain the time in which the donor acted to select a gift, if any gift is selected at all. In step 806, this past behavior is analyzed for patterns or trends. For example, it may be found that a donor only orders gifts close to the birthday of the donee, or only for a particular holiday during the year, or only for certain people and not others. In response to this analysis, the prompting is adjusted in step 804. In that regard, prompting in step 802 may occur closer in time to a given holiday or may not occur at all if the donor has not given to the donee in past similar holidays.

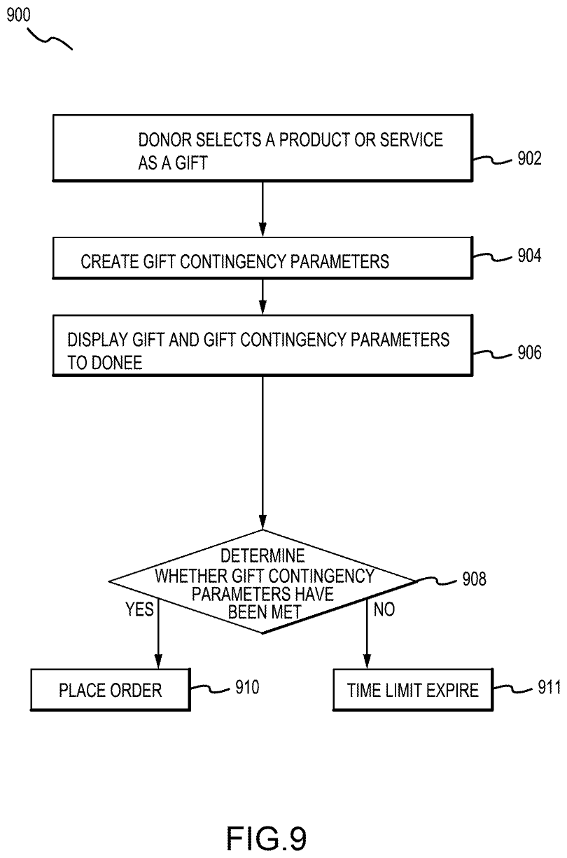

With reference to FIGS. 1A, 4, 5 and 9, a gift facilitation distributed system having a gift contingency feature and method 900 of using the same are shown. In step 902, the donor, for example via donor device 108, selects a product or service as a gift. The product or service may be any product or service the donor believes the donee would like to accept. The selection may be made via donor device 108 while accessing at least one of the gift facilitation system 102 and/or online merchant 104. In that regard, the product or service may be available for purchase from online merchant 104. However, in various embodiments, the product or service may be currency (e.g., cash), cryptocurrency, or an in-app or in-game purchase in a gaming or app environment. For example, the product or service may be the purchase of various in-game “skins,” weapons, tools, virtual currency, or add-on packs within a gaming system.

In step 904, donor device 108 may set gift contingency parameters. Gift contingency parameters include any of the gift contingency parameters set forth herein, for example those described with reference to FIG. 3, including, for example, a time limit in which another gift contingency parameter must become true prior to an order being placed. In various embodiments, donor device 108 may provide payment to the gift facilitation system 102 and/or online merchant 104 at or near the time of setting the gift contingency parameters. In this manner, the gift facilitation system 102 and/or online merchant 104 may realize payment even though a period of time may elapse prior to the gift contingency parameters occurring. Step 904 may be considered the start of a challenge campaign, and, in that regard, multiple donees may be identified and/or a maximum number of donees may be specified by donor device 108. Moreover, an expanding number of donees may be identified, such that any donee to comply with the gift contingency parameters may be included, up to, for example, a maximum number of donees. In that regard, businesses or individuals may act as donors to incentivize certain behaviors amongst a set of donees that are unknown at the outset of the challenge campaign.

In step 906, the gift and the gift contingency parameters are displayed to a donee or set of potential donees, for example via donee device 106 and/or via social media outlets, advertisements, or other broadcast media. Donee device 106 may provide data to at least one of the gift facilitation system 102 and/or online merchant 104 to indicate an “opt in” or otherwise indicate a willingness to attempt to meet the gift contingency parameters. In various embodiments, the donee device provides private gift parameters, as described above, that are shielded from (e.g., not provided to) the donor device 108.

In step 908, at least one of the gift facilitation system 102 and/or online merchant 104 determines whether the gift contingency parameters are met and identifies one or more donees who have met the gift contingency parameters. Where method 900 is implemented by a system as depicted in FIG. 5, distributed ledger 450 may be updated by feedback device 452 to record evidence of the meeting of gift contingency parameters. Use of distributed ledger 450 may act to verify that gift contingency parameters are met and to identify the order of donees who have met the gift contingency parameters, where the challenge campaign is open to multiple donees. In that regard, the distributed ledger 450 acts as an immutable “scoreboard” to communicate with donees and to authenticate progress towards meeting the gift contingency parameters.

In various embodiments, donor device 108 may provide input to notify at least one of the gift facilitation system 102 and/or online merchant 104 of the fulfillment of the gift parameter. However, in various embodiments, at least one of the gift facilitation system 102 and/or online merchant 104 may be notified of the fulfillment of the gift contingency parameter by a third party system or device, such as feedback device 406. In various embodiments, at least one of the gift facilitation system 102 and/or online merchant 104 may access the distributed ledger 450 to determine whether the gift contingency parameters have been met.

In step 910, the order for the gift is placed by at least one of the gift facilitation system 102 and/or online merchant 104. The order may be placed using the private gift parameters. In this manner, certain data of the donee is shielded from the donor, as described above. In various embodiments, gift facilitation system 102 may cause a currency transfer, a cryptocurrency transfer, or other transfer of virtual currency or the like to the donee. The private gift parameters may include a donee controlled “eWallet” or the like to receive a deposit of cryptocurrency or virtual currency.

In step 911, the time limit expires with no donee meeting the gift contingency parameters. No further action may be taken.

The technologies described herein may be incorporated into any of the components, devices, and systems described herein.

In various embodiments, donor devices, donee devices, and other systems may incorporate hardware and/or software components. For example, a web client running on a donor device and/or a donee devices may comprise a server appliance running a suitable server operating system (e.g., MICROSOFT INTERNET INFORMATION SERVICES or, “IIS”). Web client 150 may be any device that allows a user to communicate with a network (e.g., a personal computer, personal digital assistant (e.g., IPHONE®, BLACKBERRY®), tablet, cellular phone, kiosk, and/or the like). Donor devices, donee devices, and other systems includes any device (e.g., personal computer, mobile device, etc.) which communicates via any network, for example such as those discussed herein. In various embodiments, donor devices, donee devices, and other systems may comprise and/or run a browser, such as MICROSOFT® INTERNET EXPLORER®, MOZILLA® FIREFOX®, GOOGLE® CHROME®, APPLE® Safari, or any other of the myriad software packages available for browsing the internet. For example, the browser may communicate with a server via network by using Internet browsing software installed in the browser. The browser may comprise Internet browsing software installed within a computing unit or a system to conduct online transactions and/or communications. These computing units or systems may take the form of a computer or set of computers, although other types of computing units or systems may be used, including laptops, notebooks, tablets, handheld computers, personal digital assistants, set-top boxes, workstations, computer-servers, mainframe computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. In various embodiments, browser may be configured to display an electronic channel.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy”, “meet”, “match”, “associated with” or similar phrases may include an identical match, a partial match, meeting certain criteria, matching a subset of data, a correlation, satisfying certain criteria, a correspondence, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) a payment form and (ii) an address. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

For example, gift facilitation module 102 and online merchant 104 and 110 may comprise a server appliance running a suitable server operating system (e.g., MICROSOFT INTERNET INFORMATION SERVICES or, “IIS”) and having database software (e.g., ORACLE) installed thereon. Gift facilitation module 102 and online merchant 104 and/or online merchant 110 may be in electronic communication with one another, either directly or through various intermediaries and/or networks.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA® 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

An online merchant, as used herein, may also be an online marketplace. An online marketplace may be an online seller of goods and services that sells both goods and services from its own inventory and from the inventory of other sellers that have access to the online marketplace.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

For the sake of brevity, conventional data networking, application development, and other functional aspects of the system may not be described in detail herein. Furthermore, the connecting lines shown in the various figures contained herein are intended to represent exemplary functional relationships and/or electronic communications between the various elements. It should be noted that many alternative or additional functional relationships or electronic communications may be present in a practical system.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: donor data; donee data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by artificial intelligence (AI) or machine learning. Artificial intelligence may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Any communication, transmission, communications channel, channel, and/or the like discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website, mobile application, or device (e.g., FACEBOOK®, YOUTUBE®, PANDORA®, APPLE TV®, MICROSOFT® XBOX®, ROKU®, AMAZON FIRE®, GOOGLE CHROMECAST™, SONY® PLAYSTATION®, NINTENDO® SWITCH®, etc.) a uniform resource locator (“URL”), a document (e.g., a MICROSOFT® Word™ or EXCEL®, an ADOBE® Portable Document Format (PDF) document, etc.), an “ebook,” an “emagazine,” an application or microapplication (as described herein), an SMS or other type of text message, an email, a FACEBOOK® message, a TWITTER® tweet, multimedia messaging services (MMS), and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network, and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, LINKEDIN®, INSTAGRAM®, PINTEREST®, TUMBLR®, REDDIT®, SNAPCHAT®, WHATSAPP®, FLICKR®, VK®, QZONE®, WECHAT®, and the like. Examples of affiliate or partner websites include AMERICAN EXPRESS®, GROUPON®, LIVINGSOCIAL®, and the like. Moreover, examples of mobile device communications include texting, email, and mobile applications for smartphones. Gifts as disclosed herein may include subscriptions or upgrades within the distribution channels.

The systems, computers, computer-based systems, and the like disclosed herein may provide a suitable website or other internet-based graphical user interface which is accessible by users. Practitioners will appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf, which is hereby incorporated by reference in its entirety.

In various embodiments, the system and various components may integrate with one or more smart digital assistant technologies. For example, exemplary smart digital assistant technologies may include the ALEXA system developed by AMAZON®, GOOGLE HOME®, APPLE® HOMEPOD®, and/or similar digital assistant technologies. AMAZON® ALEXA, GOOGLE HOME®, and APPLE® HOMEPOD®, may each provide cloud-based voice activation services that can assist with tasks, entertainment, general information, and more. All AMAZON® ALEXA devices, such as the AMAZON ECHO®, AMAZON ECHO DOT®, AMAZON TAP®, and AMAZON FIRE® TV, have access to the ALEXA system. The ALEXA, GOOGLE HOME®, and APPLE® HOMEPOD® systems may receive voice commands via its voice activation technology, and activate other functions, control smart devices, and/or gather information. For example, the smart digital assistant technologies may be used to interact with music, emails, texts, calling, question answering, home improvement information, smart home communication/activation, games, shopping, making to-do lists, setting alarms, streaming podcasts, playing audiobooks, and providing weather, traffic, and other real time information, such as news. The ALEXA, GOOGLE HOME®, and APPLE® HOMEPOD® systems may also allow the user to access information about eligible transaction accounts linked to an online account across all digital assistant-enabled devices.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT and XML) programs, helper applications, plug-ins, and the like. A server may include a web service that receives a request from a web server, the request including a URL and an IP address (192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. As a further example, representational state transfer (REST), or RESTful, web services may provide one way of enabling interoperability between applications.

In various embodiments, one or more servers discussed herein may include application servers (e.g., WEB SPHERE®, WEBLOGIC JBOSS®, POSTGRES PLUS ADVANCED SERVER®, etc.). In various embodiments, the server may include web servers (e.g. Apache, IIS, GOOGLE® Web Server, SUN JAVA® System Web Server, JAVA® Virtual Machine running on LINUX® or WINDOWS® operating systems, etc.).

A firewall may include any hardware and/or software suitably configured to protect CMS components and/or enterprise computing resources from users of other networks. Further, the firewall may be configured to limit or restrict access to various systems and components behind the firewall for web clients connecting through a web server. The firewall may reside in varying configurations including Stateful Inspection, Proxy based, access control lists, and Packet Filtering among others. The firewall may be integrated within a web server or any other CMS components or may further reside as a separate entity. The firewall may implement network address translation (“NAT”) and/or network address port translation (“NAPT”). The firewall may accommodate various tunneling protocols to facilitate secure communications, such as those used in virtual private networking. The firewall may implement a demilitarized zone (“DMZ”) to facilitate communications with a public network such as the internet. The firewall may be integrated as software within an internet server, integrated into any other application server components, reside within another computing device, or take the form of a standalone hardware component.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager such as, for example, Parallel Multithreaded Machine (“PM2”); a resource and performance monitoring tool such as, for example, Node Application Metrics (“appmetrics”); a library module for building user interfaces, and/or any other suitable and/or desired module.

Further, illustrations of the process flows and the descriptions thereof may make reference to user WINDOWS® applications, webpages, websites, web forms, prompts, etc. Practitioners will appreciate that the illustrated steps described herein may comprise in any number of configurations including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

As will be appreciated by one of ordinary skill in the art, the system or any of its components may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet-based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general-purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager such as, for example, Parallel Multithreaded Machine (“PM2”); a resource and performance monitoring tool such as, for example, Node Application Metrics (“appmetrics”); a library module for building user interfaces, and/or any other suitable and/or desired module.

As used herein, “electronic communication” may comprise a physical coupling and/or non-physical coupling capable of enabling system components to transmit and receive data. For example, “electronic communication” may refer to a wired or wireless protocol such as a CAN bus protocol, an Ethernet physical layer protocol (e.g., those using 10BASE-T, 100BASE-T, 1000BASE-T, etc.), an IEEE 1394 interface (e.g., FireWire), Integrated Services for Digital Network (ISDN), a digital subscriber line (DSL), an 802.11a/b/g/n/ac signal (e.g., Wi-Fi), a wireless communications protocol using short wavelength UHF radio waves and defined at least in part by IEEE 802.15.1 (e.g., the BLUETOOTH® protocol maintained by Bluetooth Special Interest Group), a wireless communications protocol defined at least in part by IEEE 802.15.4 (e.g., the ZIGBEE® protocol maintained by the ZigBee alliance), a cellular protocol, an infrared protocol, an optical protocol, or any other protocol capable of transmitting information via a wired or wireless connection. All gift facilitation systems, online merchants, feedback devices, donor devices, donee devices, and locks, may be in electronic communication with one another.

As used herein, “transmit” may include sending electronic data from one system component to another over a network connection. Additionally, as used herein, “data” or “information” may include encompassing information such as commands, queries, files, data for storage, and the like in digital or any other form.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

No claim element is intended to invoke 35 U. S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
receiving, at a gift facilitation system, donee preferences;
curating, by the gift facilitation system, at least one of a product or a service based on the donee preferences;
displaying, by the gift facilitation system, the curated at least one of a product and a service; and
transmitting, by the gift facilitation system, an order to a merchant system.

2. The method of claim 1, wherein the gift facilitation system receives the donee preferences from a donee device.

3. The method of claim 2, wherein the donee preferences comprise at least one of food and diet restriction preferences, brand preferences, activity preferences, and travel and vacation preferences.

4. The method of claim 2, wherein the curating further comprises querying, by the gift facilitation system, the merchant system to determine whether the merchant system provides the at least one of the product and the service.

5. The method of claim 4, wherein the curating comprises receiving, by the gift facilitation system, at least one of a SKU and an item number from the merchant system in response to the querying.

6. The method claim 5, further comprising transmitting, by the gift facilitation system, the at least one of the SKU and the item number to the donee device and receiving, at the gift facilitation system from the donee device, private gift parameters associated with the at least one of the SKU and the item number.

7. The method of claim 1, further comprising receiving, at the gift facilitation system, gift contingency parameters from a donor device.

8. A system comprising:
gift facilitation system in communication with a donee device and a donor device; and
a non-transitory, machine-readable memory in communication with the gift facilitation system and having instructions recorded thereon that, in response to execution by the gift facilitation system, cause the gift facilitation system to perform operations comprising:
receiving, at the gift facilitation system, donee preferences;
curating, by the gift facilitation system, at least one of a product or a service based on the donee preferences;
displaying, by the gift facilitation system, the curated at least one of a product and a service; and
transmitting, by the gift facilitation system, an order to a merchant system.

9. The system of claim 8, wherein the gift facilitation system receives the donee preferences from the donee device.

10. The system of claim 9, wherein the donee preferences comprise at least one of food and diet restriction preferences, brand preferences, activity preferences, and travel and vacation preferences.

11. The system of claim 8, wherein the curating comprises querying, by the gift facilitation system, the merchant system to determine whether the merchant system provides the at least one of the product and the service.

12. The system of claim 11, wherein the curating further comprises receiving, by the gift facilitation system, at least one of a SKU and an item number from the merchant system in response to the querying.

13. The system of claim 12, wherein the operations further comprise transmitting, by the gift facilitation system, the at least one of the SKU and the item number to the donee device and receiving, at the gift facilitation system from the donee device, private gift parameters associated with the at least one of the SKU and the item number.

14. The system of claim 8, wherein the operations further comprise receiving, at the gift facilitation system, gift contingency parameters from the donor device.

15. An article of manufacture comprising:
a non-transitory, machine-readable memory having instructions recorded thereon that, in response to execution by a gift facilitation system, cause the gift facilitation system to perform operations comprising:
receiving, at the gift facilitation system, donee preferences;
curating, by the gift facilitation system, at least one of a product and a service based on the donee preferences;
displaying, by the gift facilitation system, the curated at least one of a product and a service; and
transmitting, by the gift facilitation system, an order to a merchant system.

16. The article of manufacture of claim 15, wherein the gift facilitation system receives the donee preferences from a donee device.

17. The article of manufacture of claim 16, wherein the donee preferences comprise at least one of food and diet restriction preferences, brand preferences, activity preferences, and travel and vacation preferences.

18. The article of manufacture of claim 16, wherein the curating further comprises querying, by the gift facilitation system, the merchant system to determine whether the merchant system provides the at least one of the product and the service.

19. The article of manufacture of claim 18, wherein the curating further comprises receiving, by the gift facilitation system, at least one of a SKU and an item number from the merchant system in response to the querying.

20. The article of manufacture of claim 19, wherein the operations further comprise transmitting, by the gift facilitation system, the at least one of the SKU and the item number to the donee device and receiving, at the gift facilitation system from the donee device, private gift parameters associated with the at least one of the SKU and the item number.
